(19) United States
(12) Patent Application Publication
(10) Pub. No.: US 2009/0246725 A1
(43) Pub. Date: Oct. 1, 2009

(54) METHOD AND KIT INCLUDING STOP ELEMENTS FOR CORRECTING DENTAL MALOCCLUSIONS WITH PRE-FORMED NITINOL ARCHES

(76) Inventor: Graciela Landeros Ramirez, Guadalajara (MX)

Correspondence Address: MCDERMOTT WILL & EMERY LLP, 18191 VON KARMAN AVE., SUITE 500, IRVINE, CA, 92612-7108, US

(21) Appl. No.: 12/096,598

(22) PCT Filed: Dec. 6, 2005
(86) PCT No.: PCT/MX2005/000113

§ 371 Date: Nov. 10, 2008

(51) Int. Cl. A61C 7/20; A61C 7/00

(52) U.S. Cl. 433/20; 433/24

(57) ABSTRACT

The invention relates to a method and a kit for correcting dental malocclusions. The inventive kit consists of at least one pre-formed arch for nitinol orthodontics and at least two perforated silver spherules which when introduced into the arch and deformed remain fixed to the arch, serving as a stop element. The inventive method consists in: positioning the necessary elements; aligning the teeth with the application of the preformed nitinol dental arch, having stop elements abutting thereagainst; closing the spaces; performing a leveling step; and applying a pretorque and a torque.

### TECHNICAL FIELD OF THE INVENTION

The present invention relates to the field of orthodontics, and primarily to the devices used to correct the position of the teeth, inasmuch as it provides a method and kit for the correction of dental malocclusions, with the formation of a preformed nitinol dental arch with stops.

### BACKGROUND

The magnitude of the force that is necessary to move a tooth is very low, on the order of 0.025 g/cm², equivalent to the pressure of the capillaries of the dental system, because greater forces would cause hyalinization or necrosis and pain in the nearby tissues. Therefore, we must always measure the force that we apply to the dental system with the wires that we use. This is the case with the extremely elastic nitinol wires that we can use to shift teeth over a significant distance without developing excessive force (Atlas of Orthodontics, Principles and Applications, Dr. Anthony Vyazis, adjunct professor of orthodontics, Baylor College of Dentistry, Dallas, Tex.; 1995 edition).

Braided or twisted wires such as “Twist Flex”, “Respond”, “TripleFlex”, “Coaxial”, “Turbo”, and “Force 9” are extremely resilient and help us to relieve crowding. “Blue Elgiloy” and the Yellow version are wires that are strengthened through steel treatment. “TMA”, which is titanium-molybdenum, is a very resilient wire that can be manipulated. “Ht-Gold” for dolichodontoid Class II-1 patients who require maximum anchoring. These patients are very unstable, because of their weak musculature. Cu—NiTi is a copper alloy, and therefore is highly resilient (Clinical Diagnostics and Wire-Bending Laboratory, Dr. Guillermo del Valle and Dr. Luis Ruiz Martinez, I.D.A.P. Orthodontics, Guadalajara, Jalisco, Mexico).

The use of preformed dental arches made of nitinol (nickel-titanium) to correct the position of teeth is currently well known, and has revolutionized the field of orthodontics because of the elastic properties of this material. However, the present applicant believes that such nitinol dental arches are not used as advantageously as possible, particularly when their sliding in the tubes of the bands is not desired, such that maximum advantage is not taken of the elasticity that this material provides.

In the case of dental wires and arches made of steel, sliding is avoided by means of bends, which are easy to form because of the properties of the material. However, obviously, nitinol arches cannot be bent, because of their properties, as mentioned above.

Therefore, in order to avoid all of the above-mentioned disadvantages, a preformed dental wire with stops has been developed to prevent the sliding of the nitinol dental arches, as described hereinbelow.

### DETAILED DESCRIPTION OF THE INVENTION

The characteristic details of the method and kit for deriving maximum advantage from the nitinol dental arch to correct dental malpositionings are described hereinbelow, with the support of the accompanying figures, which are referenced solely as examples and which should not be viewed as limitative with regard to the present invention.

### BRIEF DESCRIPTION OF THE FIGURES

FIG. 1 is a traditional perspective view of the components of the kit according to the present invention.

FIG. 2 is a front view of a nitinol arch with the stops in position.

FIG. 3 is a traditional perspective view of a set of teeth in which the presence of a nitinol arch with the stops is visible.

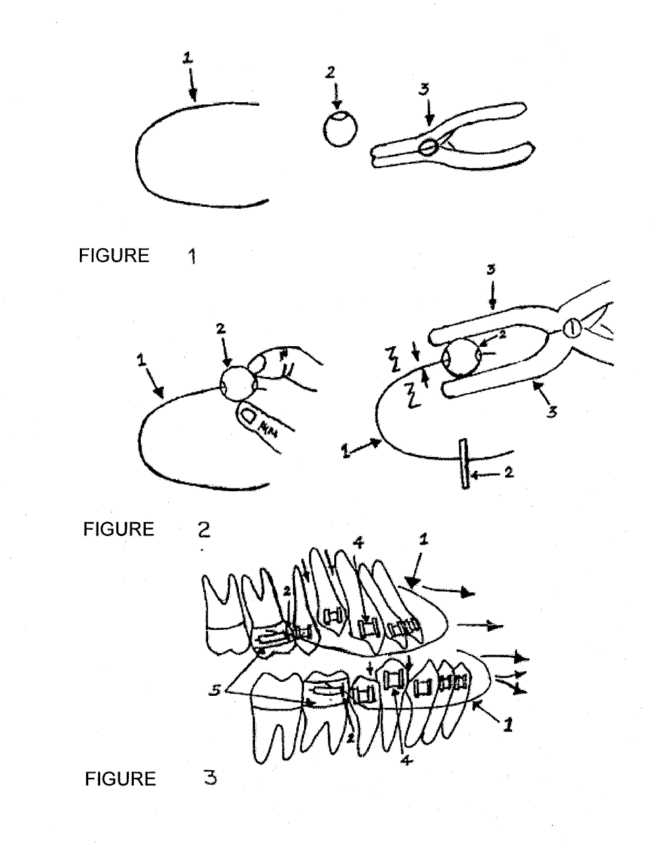

With reference now to the said figures, the kit for the correction of dental malocclusions with preformed nitinol arches consists of:
i) At least one preformed nitinol dental arch (1), of the type commonly known;
ii) At least two drilled silver spherules (2), into which the preformed nitinol dental arch (1) is introduced and is held by pressure such that the spherules remain stationary in the said dental arch (1); with one wall resting against the other, to serve as a stop in the nitinol arch (see FIG. 2).

Thus, we obtain a modified preformed dental arch (1), because of the addition of the stops (2). This is what makes the present applicant's invention novel, because thanks to this addition, the unnecessary unwanted sliding is avoided, and maximum advantage is derived from the said arch (1).

It is appropriate to mention that the said stops (2) may be added to arches made of other material, such as NiTi, that are elastic and resilient, because on the market we may encounter nitinol arches with different names, such that the characteristics, application, and force provided by each of them should be studied very assiduously before they are used in our patient.

One of the variants of the kit is that it may also include the following items:
A pair of pliers (3) that help to deform the sphere (2), causing the sphere to remain secured in the arch, thus forming the said stop, which prevents the sliding; however, this part may be optional; and/or
A bottle containing an astringent solution that removes grease, saliva, and food particles that might adhere to the preformed nitinol arch during the trial period.

Therefore, the present invention also includes a method for the correction of dental malpositionings, characterized by the following stages:
i) Installation of the brackets (4) and the bands (5) that are essential parts of the treatment and that have the traditional shape, depending on the selected technique.
ii) Alignment of the teeth, which takes place by means of the selected wire, depending on the individual case and on the orthodontists judgment, may be a round No. 12 preformed nitinol arch (1), for which it is first necessary to measure the patient's dental arch in order to mark or indicate the exact location on the said preformed arch (1) where the stops will be located; next, the preformed dental arch (1) is treated with an astringent, in order to remove from it any food particles and grease that might prevent the perfect and durable adhesion of the stops; then it is necessary to measure the free space that will remain present between the preformed dental arch (1) and the brackets that have already been affixed to the teeth; then the ends of the preformed dental arch (1) are introduced into the tubes of the bands (5) of the molars; then the preformed dental arch (1) is introduced into the brackets (4) and are supported by multiple modules (small rubber bands, not shown); and, last, the excess ends of the preformed nitinol dental arch (1) are cut off, to prevent them from injuring the patient's cheek tissues.

It is important to emphasize that we must not exaggerate the force that is applied to the patient's dental system; therefore, this force should be measured with a Dontrix (a device for measuring, in ounces, the force that is applied), as will be explained hereinbelow.

With this stage, what we do is: vestibularization, thereby expanding our dental arch, in order to extrude, compress, or uncross a bite; eliminate crowding; etc., and therefore always taking care to ensure that the application of the forces to our patient's masticatory system is appropriate, measuring it with the Dontrix (a device that is designed to measure the forces applied by the orthodontist to the patient's masticatory system). These forces should be from 2 to 4 ounces (28.5 g is the force of 1 ounce, thus 57 g (2 ounces), and 114 g would correspond to 4 ounces; 3.5 ounces=approximately 100 g (99.75 g)), with No. 12 round wire, because whether the teeth are being distalized, vestibularized, compressed, extruded, or repositioned, there is an optimal physiological force, and this way we will not cause damage and will avoid problems. However, these factors must be taken into consideration with the heavier wire (Biomechanics, by Dr. Luis Ruiz Martinez, I.D.A.P. Orthodontics, Guadalajara, Jalisco, Mexico).

Likewise in accordance with the descriptive classification of dental movement, as published in Burstone, Clinical Orthodontics, José Antonio Canut Bruzola, School of Medicine of the University of Valencia, 1992 edition, the movement that we impart with this technique is massive.
iii) Repositioning of the brackets in a balanced manner on all of the teeth, in a traditionally known manner.
iv) The installation of 0.016×0.022 rectangular wire in order to produce pretorque (this wire may be made of nitinol, which gives us control of the crown-root inclination) and conventional rubber bands, as needed, in order to prevent the teeth from returning to their initial position.
v) Torque or termination, which activity requires a stainless-steel 0.018×0.022 rectangular wire, in accordance with classic traditional practice, which completely fills the groove of the bracket, thus providing maximum torque control. The rubber bands are the traditional type, as necessary.

The method described hereinabove may have certain variants, which will depend on what the individual case or on the patient be treated, including, for example, the following ones:

To correct crossbites, in stage (ii) (“alignment of the teeth”) we also require a small plate, applied in the traditional manner, to lift the bite. This stage is very easy to implement, because with the aid of the stop provided by the spherule (2), our treatment is simplified, very possibly saving a great deal of work and a large number of steps, while also deriving maximum advantage from the preformed nitinol arch (1).

The act of closing the spaces left by extractions can be performed in stage (ii) (“alignment of the teeth”) through distalization or mesialization, as required. This act is performed in the traditional manner, through the use of an “Alastic” elastic chain, bends in the wire, or any other appropriate device, as well as through the use of traditional rubber bands, if necessary.

When the leveling is not achieved with stage (ii), dental leveling of the curve of Spee will have to be performed, in order to bring the teeth into a normal vertical position, within the alveolus and in relation to the adjacent teeth. This procedure is performed in the traditional manner and with the use of the classically employed elements.

1. A kit for the correction of dental malocclusions with preformed nitinol arches, characterized in that it consists of at least one preformed nitinol dental arch of the commonly known type and at least two drilled silver spherules, into which the preformed nitinol dental arch is introduced and is held by pressure such that remain stationary in the said dental arch.

2. A kit for the correction of dental malocclusions according to claim 1, characterized in that it includes a pair of pliers that help to deform the sphere, causing the sphere to remain secured in the arch.

3. A kit for the correction of dental malocclusions according to claim 1 and/or claim 2, characterized in that it includes a bottle containing an astringent solution that removes grease, saliva, and food particles that might adhere to the preformed nitinol arch.

4. A preformed dental arch that is modified for the correction of dental malocclusions, of the type consisting of a nitinol wire, characterized in that on the said wire at least two stops, formed by the deformation of two spherules, are located adjacent to each other at a certain distance from each other.

5. A method for the correction of dental malpositionings, which method includes these stages consisting of the installation of the brackets and the bands; the alignment of the teeth; the repositioning of the brackets; pretorque; and torque or termination, characterized in that the stage consisting of the alignment of the teeth is performed by means of a wire, selected as applicable and at the orthodontist's discretion, which wire may consist of a round No. 12 preformed nitinol wire, such that first the patient's dental arch is measured in order to mark or indicate the exact location on the said preformed arch where the stops will be located; next, the preformed dental arch is treated with an astringent, in order to remove from it any food particles and grease that might prevent the perfect and durable adhesion of the stops; then the free space that will remain present between the preformed dental arch and the brackets that have already been affixed to the teeth is measured; then the ends of the preformed dental arch are introduced into the tubes of the bands of the molars; then the preformed dental arch is introduced into the brackets and are supported by multiple modules (small rubber bands); and, last, the excess ends of the preformed nitinol dental arch are cut off, to prevent them from injuring the tissues of the patient's cheeks.

6. A method for the correction of dental malpositionings according to claim 5, characterized in that the stage consisting of the alignment of the teeth requires the correction of a crossbite, for which purpose a small plate is used to raise the bite, which small plate is applied in the traditional manner.

7. A method for the correction of dental malpositionings according to claim 5, characterized in that in the stage consisting of the alignment of the teeth, in some cases it is necessary to close up spaces when extractions have been performed, which task may be performed through distalization or mesialization, as required.

8. A method for the correction of dental malpositionings according to claim 5, characterized in that when, in the stage consisting of the alignment of the teeth, the leveling of the teeth is not achieved, it is necessary to perform a dental leveling of the curve of Spee, in order to bring the teeth into a normal vertical position, within the alveolus and in relation to the adjacent teeth, which procedure is performed in the traditional manner and with the use of the classically employed elements.
